(19) United States
(12) Patent Application Publication
(10) Pub. No.: US 2017/0116217 A1
(43) Pub. Date: Apr. 27, 2017

(54) HIGH BIT RATE COVERT CHANNEL IN CLOUD STORAGE SYSTEMS

(71) Applicant: Intellectual Ventures Hong Kong Limited, Central (HK)

(72) Inventors: Jianping Wang, Kowloon Tong (HK); Hermine Hovhannisyan, Kowloon (HK); Yang Rongwei, Kowloon Tong (HK)

(73) Assignee: Intellectual Ventures Hong Kong Limited, Central (HK)

(21) Appl. No.: 15/032,331

(22) PCT Filed: Mar. 24, 2015
(86) PCT No.: PCT/CN2015/074931

§ 371 Date: Apr. 27, 2016

(51) Int. Cl. G06F 17/30; H04L 29/08

(52) U.S. Cl. CPC G06F 17/30156; H04L 67/06; H04L 67/1097

(57) ABSTRACT

Technologies are generally described for high bit rate covert channels in cloud storage systems utilizing cross-user source-based data deduplication. According to some examples, an insider program sharing the same physical machine in a cloud storage system may generate message files and upload to the cloud storage system whenever the victim starts to upload his/her files. The uploaded message files may be generated to indicate time (e.g., start and end time of message file uploads). A capturer may be capable of generating same message files as the insider using the same file generation program. The capturer may decode multi-bit messages by uploading a set of possible message start and end files to the cloud storage system and detecting message files uploaded by the insider based on deduplication at the cloud storage system.

### BACKGROUND

Unless otherwise indicated herein, the materials described in this section are not prior art to the claims in this application and are not admitted to be prior art by inclusion in this section.

With the rapid increase in the use of mobile devices, shifting data into the cloud has become more than a choice, but a necessity in many cases for individuals and enterprises. People want to access their data anywhere; that is one reason why the growth in cloud storage services has become exponential. Despite the rapid increase in use of cloud storage services, security still remains a major challenge. With the growth of number of users and amount of stored data, many cloud storage providers use data deduplication to reduce the need for physical storage resources and network bandwidth consumption. Deduplication, in turn, may lead to a high risk of data leakage. Covert channel attacks in cloud storage systems are one of the risks frequently mentioned and studied. To mitigate the risk of covert channel attacks and to protect their reputation, some cloud storage providers stopped using cross-user source-based data deduplication, but many providers still use cross-user data deduplication.

### SUMMARY

The present disclosure generally describes techniques related to high bit rate covert channels in cloud storage systems.

According to some examples, methods to provide a multi-bit message over a covert channel in cloud storage systems are described. An example method may include uploading a message start file to a cloud storage by an insider residing on the same computing device as the victim in response to detection of a file upload action by a victim residing on a computing device, where the message start file includes a start time; uploading a number of message information files to the cloud storage by the insider, where each message information file includes a distinct timestamp, and uploading a message end file to the cloud storage by the insider, where the message end file includes an end time while the victim is continuing the file upload action, and stopping the uploading of the message information files or the message end file in response to detection of a completion of the file upload action by the victim.

According to other examples, methods to decode a multi-bit message over a covert channel in cloud storage systems are described. An example method may include uploading a set of possible message start files to a cloud storage by a capturer, where the set of possible message start files include a first set of distinct timestamps; uploading a set of possible message end files by the capturer in response to detection of a deduplication of one of the set of possible message start files at the cloud storage, where the set of possible message end files include a second set of distinct timestamps; uploading a set of possible message information files corresponding to a start timestamp and an end timestamp defined by the deduplicated message start file and the deduplicated message end file to the cloud storage by the capturer in response to detection of a deduplication of one of the set of possible message end files at the cloud storage; and decoding the multi-bit message uploaded by an insider to the cloud storage based on a detection of which of the uploaded message information files are deduplicated at the cloud storage.

According to further examples, systems configured to provide a multi-bit message exchange over a covert channel in cloud storage systems are described. An example system may include an insider module configured to execute on a first computing device that hosts a victim configured to upload files to a cloud storage. The insider module may be further configured to upload a message start file to the cloud storage in response to detection of a file upload action by the victim, where the message start file includes a start time. The insider module may upload a number of message information files to the cloud storage, where each message information file includes a distinct timestamp, and upload a message end file to the cloud storage, where the message end file includes an end time while the victim is continuing the file upload action, and stop the upload of the message information files or the message end file in response to detection of a completion of the file upload action by the victim. The system may also include a capturer module configured to execute a second computing device communicatively coupled to the cloud storage. The capturer module may upload a set of possible message start flies to the cloud storage, where the set of possible message start files include a first set of distinct timestamps; upload a set of possible message end files in response to detection of a duplication of one of the set of possible message start files at the cloud storage, where the set of possible message end files include a second set of distinct timestamps; upload a set of possible message information files corresponding to a start timestamp and an end timestamp defined by the deduplicated message start file and the deduplicated message end file in response to detection of a deduplication of one of the set of possible message end files at the cloud storage; and decode the multi-bit message uploaded by the insider to the cloud storage based on a detection of which of the uploaded message information files are deduplicated at the cloud storage.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example message transfer from an insider and message decoding by a capturer in a high bit rate covert channel system;

FIG. 2 illustrates in example file structure for message files exchanged in a high bit rate covert channel system;

FIG. 3 illustrates an example transmission model for a high bit rate covert channel system;

FIG. 4 illustrates example actions by an insider in a high bit rate covert channel system;

FIG. 5 illustrates example actions by a capturer in a high bit rate covert channel system;

FIG. 6 illustrates a general purpose computing device, which may be used to provide a high, bit rate covert channel system;

FIG. 7 is a flow diagram illustrating an example process to provide a high bit rate covert channel system that may be performed by a computing device such in the computing device in FIG. 6; and

FIG. 8 illustrates a block diagram of an example computer program product, all arranged in accordance with at least some embodiments described herein

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments my be used, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, among other things, to methods, apparatus, systems, devices, and/or computer program products related to high bit rate covert channels in cloud storage systems.

Briefly stated, technologies are generally described for high bit rate covert channels in cloud storage systems utilizing cross-user, source-based data deduplication. According to some examples, an insider program sharing the same physical machine in a cloud storage system may generate message files and upload to the cloud storage system whenever the victim starts to upload his/her files. The uploaded message files may be generated to indicate time (e.g., start and end time of message file uploads). A capturer may be capable of generating same message files as the insider using the same file generation program. The capturer may decode multi-bit messages by uploading a set of possible message start and end files to the cloud storage system and detecting message files uploaded by the insider based on deduplication at the cloud storage system.

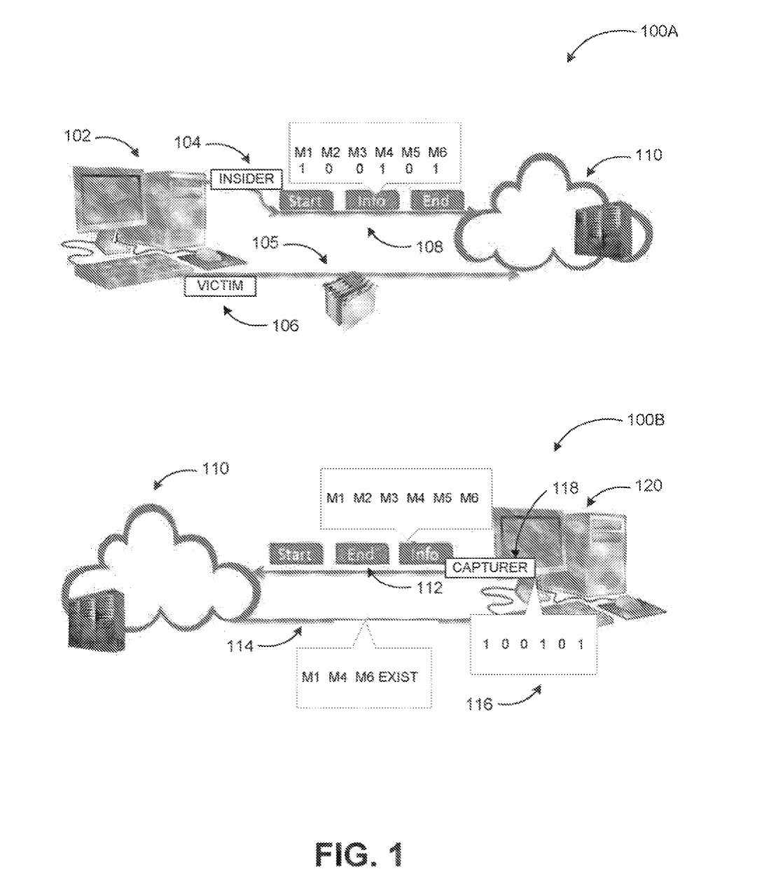

FIG. 1 illustrates an example message transfer from an insider and message decoding by a capturer in a high bit rate covert channel system, arranged in accordance with at least some embodiments described herein.

Data deduplication is a mechanism of reducing storage cost by eliminating the redundant data. Each piece of data in a cloud storage system may be identified by a hash value, which may be used for the deduplication detection. The cloud storage system may store original data instead of storing multiple copies of the same data. Data deduplication may be classified into two types: single-user deduplication and cross-user deduplication. In the single-user deduplication, the deduplication may occur when the same user uploads redundant data. In the cross-user deduplication, if a different user attempts to upload data that already exists in the cloud storage system, the data may not be uploaded and the cloud storage system may allocate a link of the original data, to the user. Data deduplication may be source- or target-based. Source-based deduplication may occur at the client side and target-based deduplication may occur at a cloud storage server. While example embodiments are discussed in cross-user, source-based deduplication environments, similar approaches may be implemented in other environments too using the principles described herein.

As shown in a diagram 100A, an insider 104 may be a program that is executed on a same computing device 102 as a victim 106, without knowledge of the victim 106. The insider 104 may work with a capturer to detect files 105 uploaded to a cloud storage system 110 by the insider 104 through the victim's computing device 102. According to some examples, the insider 104 may start operating when the victim 106 starts uploading the files 105 to the cloud storage system 110. The cloud storage system 110 may have a local folder in the computing device 102, for the victim 106 to copy files to. Files copied to the local folder may be synchronized (uploaded to) with the cloud, storage system 110. The synchronization/upload may he real time or delayed depending on configuration (for example, at low network traffic times). Once the victim 106 starts to upload the files 105, the insider 104 may upload a number of pre-generated message files 108 to the victim's folder at the cloud storage system 110. A time span during which the message files are to be generated may be agreed upon by the insider 104 and a capturer.

The insider 104 may upload three types of files: a message start file (MSGstart), which may include a beginning time of the message; a message information file (MSGinfo), which may include the main message; and a message end file (MSGend), which may include the time when message transmission finished. When the victim's upload of files finishes, the insider 104 may also stop transferring message (that is, by uploading the MSGend).

Between the MSGstart and the MSGend, the insider 104 may upload multiple MSGinfo files. The message information files may be binary encoded. The capturer and the insider may agree on a time interval in advance. At each agreed time interval, the insider 104 may either upload a file to indicate “1” or refrain from uploading to indicate “0”. For example, in the diagram 100A, the insider 104 may upload message information files M1, M4, and M6, but not M2, M3, and M5. In some embodiments, the message files (including the pre-generated message start, message end, and message information files) may be deleted automatically from the victim's folder after the upload of ail files to help the insider 104 to stay unnoticed.

As shown in a diagram 100B, a capturer 118 executing on a computing device 120 may decode a message sent by the insider 104 and thereby detect data uploaded by the victim 106 to the cloud storage system 110 by uploading possible message files to the cloud storage system 110 and confirming their deduplication. Each of the pre-generated message files 108 for the insider 104 may be encoded with distinct timestamps. Similarly, each of pre-generated message files 112 for the capturer 118 may be encoded with distinct timestamps, but the timestamps for corresponding pairs of the pre-generated message files 108 and the pre-generated message files 112 may be the same.

To ensure that pre-generated message files 108 for the insider 104 and the pre-generated message files 112 for the capturer 118 with, same timestamps can be deduplicated, the insider 104 and the capturer 118 may use the same message file generator or similar technique to generate identical message files for identical timestamps. The capturer 118 may first upload a number of possible MSGstart and MSGend files. If one of the MSGstart and another one of the MSGend files are already at the cloud storage system 110, the MSGstart and MSGend files at the cloud storage system 110 may not be uploaded from the capturer's computing device (instead de-duplicated). Thus, the capturer 118 may determine which MSGstart and MSGend files have been uploaded by the insider 104, and thereby determine a start time and an end time of the upload by the insider 104 (and thereby by the victim 106). Having determined the time period in which message information files have been uploaded by the insider 104, the capturer 118 may upload possible MSGinfo files (e.g., M1 through M6 based on how many would fit into the determined time period). Again, because deduplicated files are not uploaded, the capturer 118 may determine which of the MSGinfo files already exist in the cloud storage system 110. Based on that information, the capturer may determine the binary code transmitted by the insider 104. In the above example, the capturer 118 may determine that M1, M4, and M6 exist at the cloud storage system corresponding to a decoded message 116 of “100101”.

Some cloud storage providers may not delete files from their serves for a long or extended period of time (e.g., one month). In that scenario, the capturer 118 may periodically check to determine whether any files have been uploaded by uploading the possible MSGstart files for a given time period.

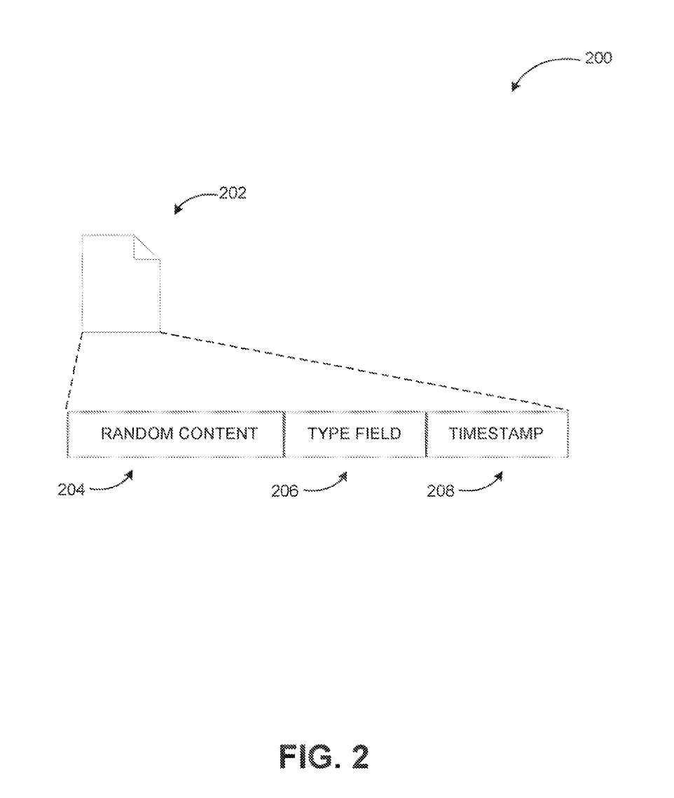

FIG. 2 illustrates an example file structure for message files exchanged in a high bit rate covert channel system, arranged in accordance with at least some embodiments described herein.

As shown in a diagram 200, a file architecture of an example message file 202 may include random content 204, a type field 206, and a timestamp 208. The random content 204 may be used to ensure that the file is random. The timestamp 208 may be based on the time the message file is generated and may be used to synchronize the message file between the insider and the capturer. The timestamp 208 may also be used to identify a serial number of the message file. The timestamp 208 may not be based on actual time according to some embodiments, and may include any number referenced by the file generator. In order to receive the message easily and accurately, the message files may be categorized into three types—MSGstart, MSGinfo, and MSGend. The type of the message file (e.g., message start file, message end file, or message information file) may be identified based on a value set in the type field 206.

The MSGstart and the MSGend files uploaded by the insider may indicate a start time, T_{S}, and an end time, T_{B}, of the message transmission through timestamps T_{S} and T_{E}. The capturer may determine from T_{S} when to start checking for MSGinfo files and from T_{E} how many MSGinfo files may be uploaded.

The MSGinfo files uploaded between T_{S} and T_{E} may each have different timestamps and may be sorted based on their timestamps. An i^{th} file may be marked as MSGinfo(i). As discussed above, if the insider uploads an MSGinfo(i), that may mean to the capturer that the i^{th} bit of message is ‘1’, otherwise, the i^{th} bit is ‘0’. According to some embodiments, ASCII encoding may be used to represent the message. For example, if letter ‘A (0100 0001)’ is transmitted, MSGinfo(2) and MSGsinfo(8) may be uploaded by the insider between MSGstart and MSGend files. Based on the T_{S} and T_{E} associated with the MSGstart and MSGend files, the capturer may expect to receive eight MSGinfo files, and thus determine that MSGinfo(1), MSGinfo(3), MSGinfo(4), MSGinfo(5), MSGinfo(6), and MSGinfo(7) have not been uploaded. That may result in the conclusion that first, third, fourth, fifth, and sixth bits are ‘0’. In some examples, the end of the message may be indicated by the character ‘NUL (0000 0000)’.

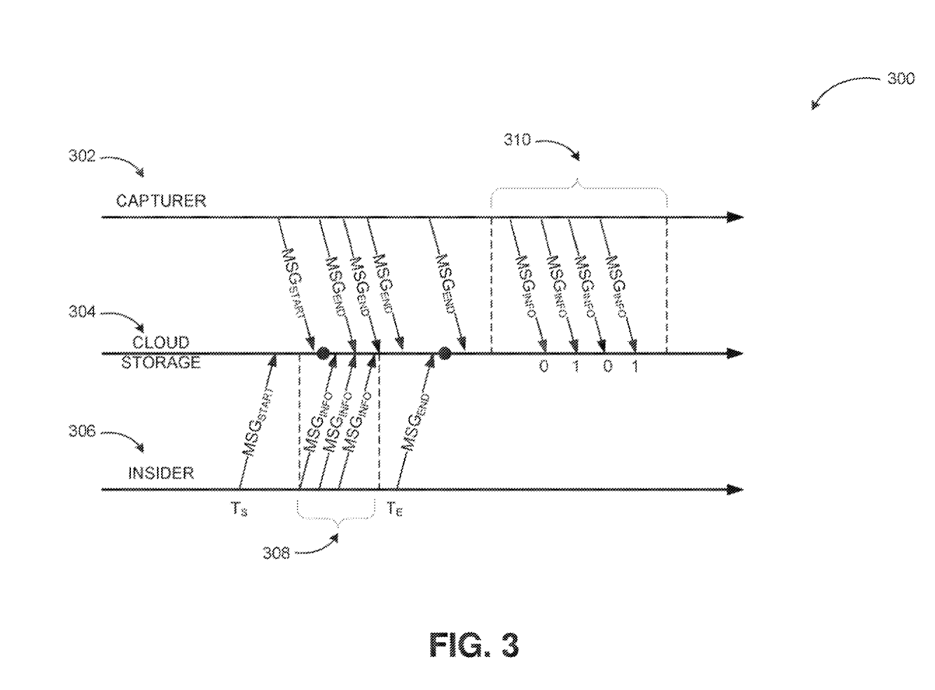

FIG. 3 illustrates an example transmission model for a high bit rate covert channel system, arranged in accordance with at least some embodiments described herein.

As shown in a diagram 300, before uploading a message file to a cloud storage system 304, an insider 306 may generates a MSGstart file with timestamp T_{S}, a number of MSGinfo files 308, and a MSGend file with timestamp T_{E}. A number of the MSGinfo files may be predefined or dynamically adjusted based on upload periods of the victim by the insider 306. When the victim starts to upload files to the cloud storage system 304, the insider 306 may begin to upload the generated message files until the victim stops uploading, at which point the MSGend file may be uploaded.

To detect the message from the insider, the capturer 302 may upload a set of the possible MSGstart files at first. When a deduplication occurs, the capturer 302 may record the timestamp Ts of the deduplicated MSGstart and begin uploading a set of the possible MSGend fifes to detect the end time of the upload period, T_{E}. The capturer 302 may detect T_{E} similarly to the detection of T_{S} based on deduplication of the MSGend files. Once T_{S} and T_{E} are determined, the capturer 302 may upload possible MSGinfo files 310 for the time period defined by the T_{S} and T_{E}. Then, based on deduplication of the MSGinfo files 310, the capturer 302 may decode the message.

By enabling high bit rate message exchange between an insider and a capturer, a system according to some embodiments may allow conveyance of information about a victim's uploaded information to the capturer. For example, timing, size, power consumption, bandwidth consumption, content, and/or comparable information about the victim can be conveyed by the insider to the capturer without the message exchange being detected by the victim or the cloud storage system.

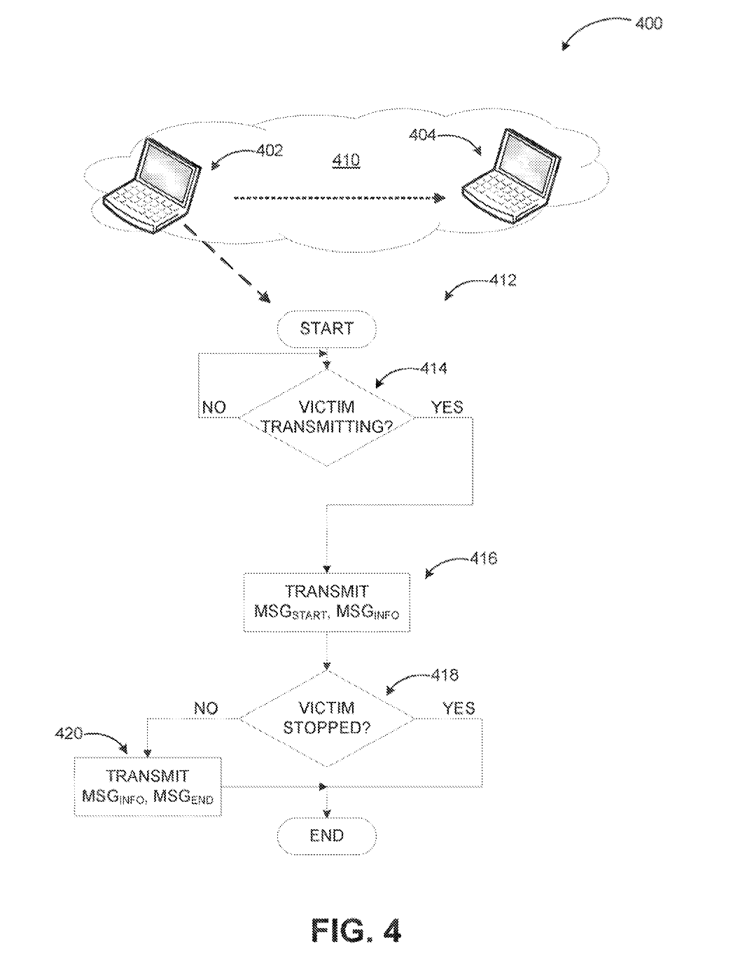

FIG. 4 illustrates example actions by an insider in a high bit rate covert channel system, arranged in accordance with at least some embodiments described herein.

As shown in a diagram 400, the actions of an insider 402 shown, in a flowchart 412 enable the insider 402 to communicate a multi-bit, covert channel message to a capturer 404 over a cloud storage system 410. The insider 402 may begin by determining whether a victim, with whom the insider 402 shares a physical machine (are co-resident), is uploading files to the cloud storage system 410 at decision operation “VICTIM TRANSMITTING?” 414. If the victim is not transmitting, the insider 402 may continue to monitor victim actions. If the victim is transmitting, the may start uploading a pre-generated MSGstart message file and multiple MSGinfo message files to the cloud storage system at operation “TRANSMIT MSGstart, MSGinfo” 416. The uploading of the MSGinfo message files may continue until the victim stops uploading files or the predefined number of MSGinfo files have all been uploaded. This is shown in the flowchart 41.2 as decision operation “VICTIM STOPPED” 418. If the victim continues to upload, upon completing the upload of MSGinfo message files, the insider 402 may upload an MSGend file indicating an end timestamp for the upload at operation “TRANSMIT MSGinfo, MSGend” 420, if the victim, stops its upload, the insider may also stop its upload process.

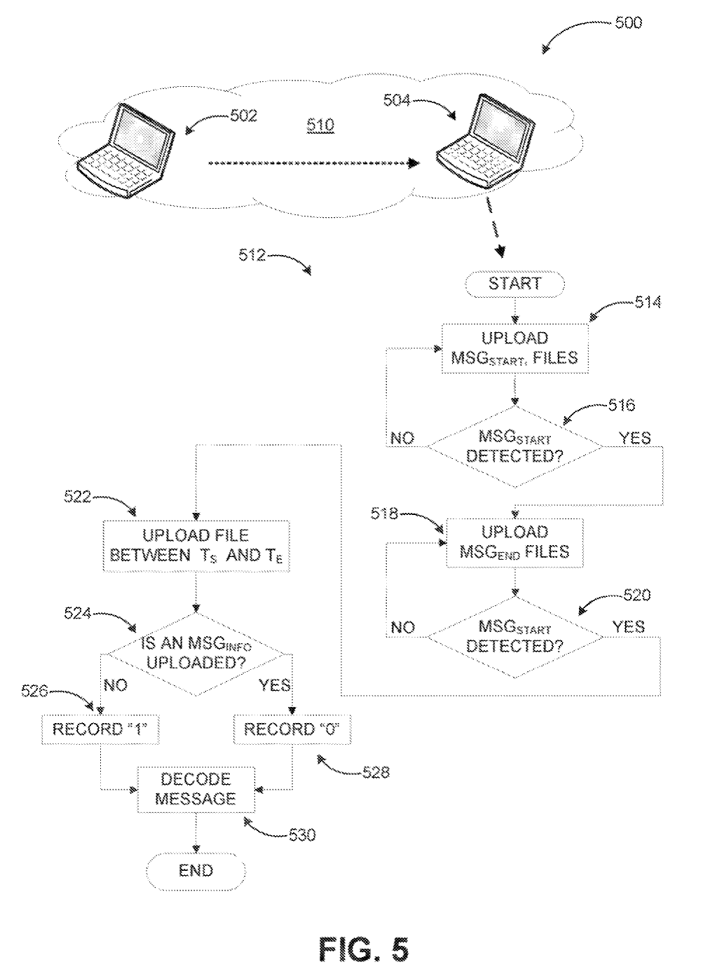

FIG. 5 illustrates example actions by a capturer in a high bit rate covert channel system, arranged in accordance with at least some embodiments described herein.

As shown in a diagram 500, the actions of a capturer 504 shown in a flowchart 512 are based on a multi-bit, encoded message uploaded to a cloud storage system 510 by an insider 502, which shares a physical machine with a victim. The capturer 504 may begin by uploading a set of MSGstart files with different timestamps at operation “UPLOAD MSGstart FILES” 514. The capturer may detect the insider's MSGstart file based deduplication of one of the set of uploaded MSGstart files at operation “MSGstart DEFECTED?” 516. If the insider's MSGstart is not detected the capturer 504 may continue to upload new sets of MSGstart files. Otherwise, the capturer may begin uploading a set of MSGend files with different timestamps at operation “UPLOAD MSGend FILES” 518. The capturer 504 may detect the insider's MSGend file also based deduplication of one of the set of uploaded MSGend files at operation “MSGend DETECTED?” 520. If the insider's MSGend is not detected, the capturer 504 may continue to upload new sets of MSGend files.

Upon detecting the insider's MSGend file at operation 520, the capturer 504 may being uploading MSGinfo files with timestamps between times T_{S} and T_{E}, corresponding to the timestamps of detected MSGstart and MSGend, respectively, at operation “UPLOAD FILE BETWEEN T_{S} and T_{E}” 322. The capturer 504 may then determine which of the uploaded MSGinfo files have been deduplicated at operation “IS AN MSGinfo UPLOADED” 524. In other words, which MSGinfo files have already been uploaded to the cloud storage system 510 by the insider 502. For files that have been uploaded by the insider 502, the capturer may record a bit “1” at operation “RECORD ‘1’” 526. Otherwise, the capturer 504 may record a bit at operation “RECORD ‘0’” 528. The recorded hits may then be used by the capturer 504 to decode the insider's message at operation “DECODE MESSAGE” 530.

The examples in FIGS. 1 through 5 have been described using specific systems and processes in which high bit rate covert channels in cloud storage systems may be implemented. Embodiments for high bit rate covert channels in cloud storage systems are not limited to the systems and processes according to these examples.

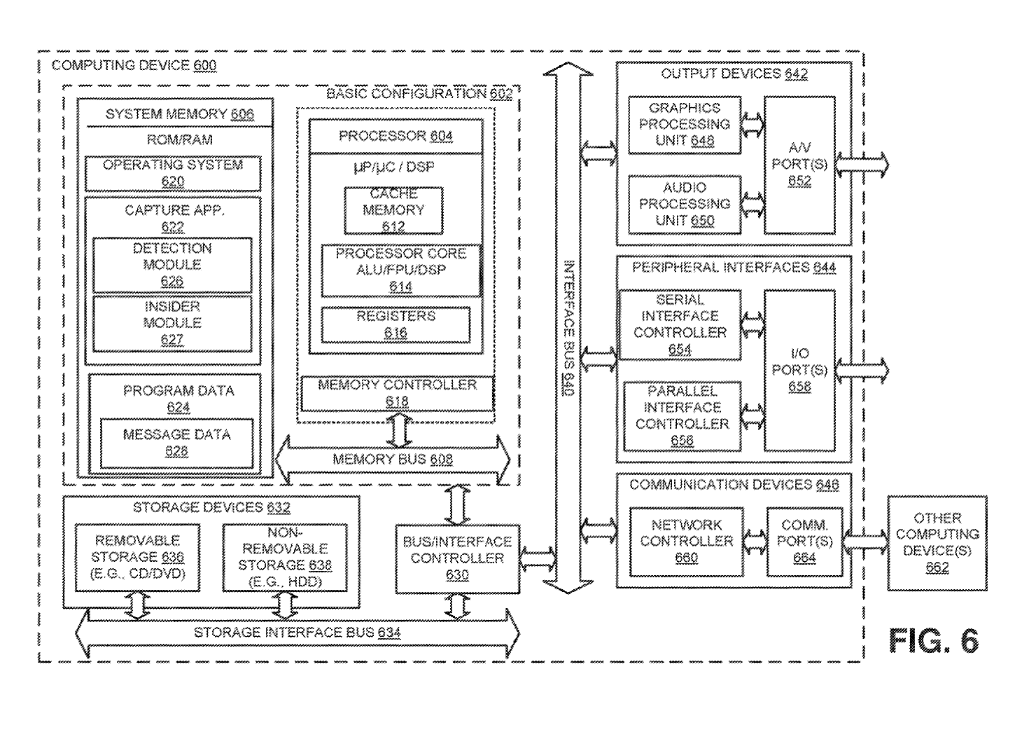

FIG. 6 illustrates a general purpose computing device, which may be used to provide a high bit rate covert channel system, arranged in accordance with at least some embodiments described herein.

For example, a computing device 600 may be used to provide computer program products related to high bit rate covert channels in cloud storage systems. In an example basic configuration 602, the computing device 600 may include one or more processors 604 and a system memory 606. A memory bus 60S may be used for communicating between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, a processor core 614, and registers 616. The example processor core 614 may include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a capture application 622, and program data 624. The capture application 622 may include a detection module 626 and an insider module 627, which may coordinate uploading of small files in parallel to a victim's uploading of their own files and detect the uploaded files through decoding of the uploaded small files based on deduplication as described herein. The program data 624 may include, among other data, message data 628, as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bits 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disc (CD) drives or digital versatile disk (DVD) drives, solid state drives (SSDs), and tape drives, to name a few. Example computer storage media, may include volatile and nonvolatile, removable, and non-removable media implemented in any method or technology for storage of information, such as computer-readable instructions, data structures, program modules, or other data.

The system memory 606, the removable storage devices 636, and the non-removable storage devices 638 may be examples of computer storage media. Computer storage media may include, but is not limited to, RAM, ROM, EEPROM, flash memory or other memory technology, CD-ROM, digital versatile disks (DVDs), solid state drives, or other optical storage, magnetic cassettes, magnetic tape, magnetic disk, storage or other magnetic storage devices, or any other medium which may be used to store the desired information and which may be accessed by the computing device 600. Any such computer storage media, may be part of the computing device 600.

The computing device 600 may also include an interface bus 640 for facilitating communication from various interface devices (for example, one or more output devices 642, one or more peripheral interfaces 644, and one or more communication devices 646) to the basic configuration 602 via the bus/interface controller 630. Some of the example output devices 642 may include a graphics processing unit 648 and an audio processing unit 650, which may be configured to communicate to various external, devices, such as a display or speakers via one or more A/V ports 652. One or more example peripheral interfaces 644 may include a serial interface controller 654 or a parallel interface controller 656, which may be configured to communicate with external devices, such as input devices (for example, keyboard, mouse, pen, voice input device, touch input device, etc.) or other peripheral devices (for example, printer, scanner, etc.) via one or more I/O posts 658. An example communication device 646 may include a network controller 660, which may be arranged to facilitate communications with one or more other computing devices 662 over a network communication link via one or more communication ports 664. The one or more other computing devices 662 may include servers, client equipment, and comparable devices.

The network communication link may he one example of a communication media. Communication media may be embodied by computer-readable instructions, data structures, program modules, or other data in a modulated data signal, such as a carrier wave or other transport mechanism, and may include any information delivery media. A “modulated data signal” may be a signal that has one or more of the modulated data signal characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media, as used herein, may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to provide high bit rate covert channels in cloud storage systems. These methods may be implemented in any number of ways, including the structures described herein. One such way may be by machine operations, using devices of the type described in the present disclosure. Another optional way may be for one or more of the individual operations of the methods to be performed in conjunction with one or more human operators performing some of the operations while other operations may be performed by machines. These human operators need, not be co-located with each other, but each may be with a machine that performs a portion of the program. In other examples, the human interaction may be automated such as by pre-selected criteria that may be machine automated.

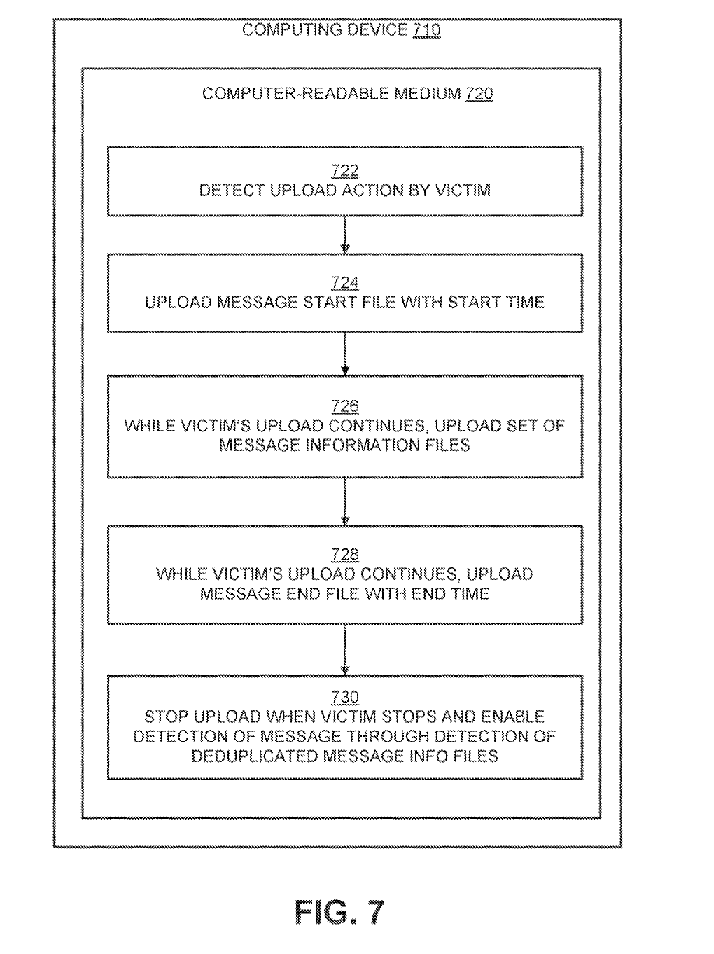

FIG. 7 is a flow diagram illustrating an example process to provide a high bit rate covert channel system that may be performed by a computing device such as the computing device in FIG. 6 arranged in accordance with at least some embodiments described herein.

Example methods may include one or more operations, functions, or actions as illustrated by one or more of blocks 722, 724, 726, 728, and 730, and may, in some embodiments, be performed by a computing device such as the computing device 600 in FIG. 6. The operations described in blocks 722-730 may also be stored as computer-executable instructions in a computer-readable medium such 720 of a computer device 710.

An example process to provide a high bit rate covert channel system may begin with block 722, “DETECT UPLOAD ACTION BY VICTIM” where an insider residing on a same physical machine as a victim may detect upload of files by the victim to a cloud storage system. For example, the cloud storage system may include a local folder at a computing device associated with the victim. Files moved to the local folder may be uploaded to the cloud storage system contemporaneously or at particular times of day.

Block 722 may be followed by block 724, “UPLOAD MESSAGE START FILE WITH START TIME;” where the insider may upload a MSGstart file that includes a timestamp indicating a start time of the upload. The SMGstart file may be pre-generated and the timestamp may be according to a pre-arranged scheme with a capturer such that real time indication is not needed.

Block 724 may be followed by block 726, “WHILE VICTIM'S UPLOAD CONTINUES, UPLOAD SET OF MESSAGE INFORMATION FILES,” where the insider may begin uploading a set of pure-generated MSFinfo files with each file including a sequential timestamp. To encode a binary coded message, the insider may skip uploading some of the MSGinfo files such that uploaded MSGinfo files may correspond to bit “T” and skipped MSGinfo files may correspond to bit “0”. The number of the MSGinfo files in the set may correspond to a number of bits in the encoding scheme, for example, eight when using ASCII coding.

Block 726 may be followed by block 728, “WHILE VICTIM'S UPLOAD CONTINUES, UPLOAD MESSAGE END FILE WITH END TIME,” where, upon completion of the upload of the set of MSGinfo files, the insider may upload a MSGend file with a timestamp indicating an end of the upload.

Block 728 may be followed by block 730, “STOP UPLOAD WHEN VICTIM STOPS AND ENABLE DETECTION OF MESSAGE THROUGH DETECTION OF DEDUPLICATED MESSAGE INFO FILES;” where the insider may stop its upload if the victim stops uploading during the upload of MSGinfo files or prior to the upload of the MSGend file. The upload of the binary encoded. MSGinfo files and identification of the start and end times through the times-lamps of the MSGstart and MSGend files may enable the capturer to decode the message from the insider by detecting which of the uploaded MSGinfo files are deduplicated by the cloud storage system.

The blocks included in the above-described process are for illustration purposes. Employment of a high bit rate covert channel system may be implemented by similar processes with fewer or additional blocks. In some embodiments, the blocks may be performed in a different order. In some other embodiments, various blocks may be eliminated. In still other embodiments, various blocks may be divided into additional blocks, or combined together into fewer blocks.

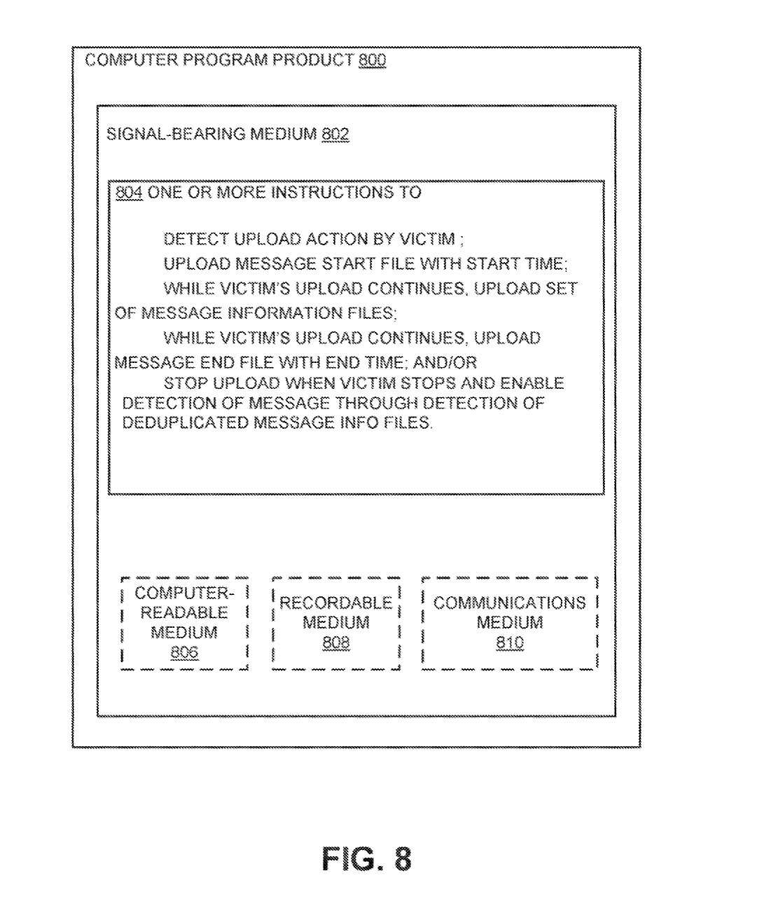

FIG. 8 illustrates a block diagram of an example computer program product, arranged in accordance with at least some embodiments described herein.

In some examples, as shown in FIG. 8, a computer program product 800 may include a signal bearing medium 802 that may also include one or more machine readable instructions 804 that, when executed by, for example, a processor, may provide the functionality described herein. For example, referring to the processor 604 in FIG. 6, the capture application 622, the detection module 626, and the insider module 627 may undertake one or more tasks shown in FIG. 8 in response to the instructions 804 conveyed to the processor 604 by the medium 802 to provide high bit rate covert channels in cloud storage systems, as described herein. Some of those instructions may include, for example, to detect upload action by victim from sender, upload message start file with start time, upload one or more message info files, each file indicating whether a file is actually uploaded or not, upload message end file with end time, enable detection of uploaded file(s) through detection of deduplicated message info files at receiver.

In some implementations, the signal bearing medium 802 depicted in FIG. 8 may encompass a computer-readable medium 806, such as, but not limited to, a hard disk drive, a solid state drive, a Compact Disk (CD), a Digital Versatile Disk (DVD), a digital tape, memory, etc. In some implementations, the signal bearing medium 802 may encompass a recordable medium 808, such as, but not limited to, memory, read/write (RAV) CDs, R/W DVDs, etc. In some implementations, the signal bearing medium 802 may encompass a communications medium 810, such as, but not limited to a digital and/or an analog communication medium (e.g., a fiber optic cable, a waveguide, a wired communications link, a wireless communication link, etc.). For example, the program product 800 may be conveyed to one or more modules of fee processor 604 by an RF signal bearing medium, where the signal bearing medium 802 is conveyed by the wireless communications medium 810 (e.g., a wireless communications medium conforming with the IEEE 802.11 standard).

According to some examples, methods to provide a multi-bit message over a covert channel in cloud storage systems are described. An example method may include uploading a message start file to a cloud storage by an insider residing on the same computing device as the victim in response to detection of a file upload action by a victim residing on a computing device, where the message start file includes a start time; uploading a number of message information files to the cloud storage by the insider, where each message information file includes a distinct timestamp, and uploading a message end file to the cloud storage by the insider, where the message end file includes an end time while the victim is continuing the file upload action; and stopping the uploading of the message information files or the message end file in response to detection of a completion of the file upload action by the victim.

According to other examples, uploading the number of message information files to the cloud storage with each message informal ion file including the distinct timestamp may include pre-generating the message information files with sequential timestamps. The sequential timestamps may have values between the start time and the end time. The method may further include generating the start time, the end time, and the timestamps of the message information files using a pre-arranged scheme with a capturer to ensure decoding of the multi-bit message by the capturer upon completion of the upload of the message end file.

According to further examples, the method may also include indicating the start time and the end time by using a start timestamp and an end timestamp, where the start timestamp and the end timestamp are based on insider generated time points. The method may further include uploading a message information file to indicate a bit “1” to a capturer and refraining from uploading a message information file to indicate a bit “0” to the capturer. The method may also include upon completion of the upload of the message end file, deleting the pre-generated message start file, the message information files, and the message end file from the computing device shared by the insider and the victim. The method may include encoding the multi-bit message according to ASCII coding, and identifying the message start file, the message information, files, and the message end file by setting a value in a file type field of each uploaded file to the cloud storage by the insider.

According to other examples, methods to decode a multi-bit message over a covert, channel in cloud storage systems are described. An example method may include uploading a set of possible message start files to a cloud storage by a capturer, where the set of possible message start files include a first set of distinct timestamps; uploading a set of possible message end files by the capturer in response to detection of a deduplication of one of the set of possible message start files at the cloud storage, where the set of possible message end files include a second set of distinct timestamps; uploading a set of possible message information files corresponding to a start timestamp and an end timestamp defined by the deduplicated message start file and the deduplicated message end file to the cloud storage by the capturer in response to detection of a deduplication of one of the set of possible message end files in the cloud storage; and decoding the multi-bit message uploaded by an insider to the cloud storage based on a detection of which of the uploaded message information files are deduplicated at the cloud storage.

According to some examples, decoding the multi-bit message based on the detection of which of the uploaded message information files are deduplicated may include assigning a bit value “1” to each deduplicated message information file. Decoding the multi-bit message based on the detection, of which of the uploaded message information files are deduplicated further may further include assigning a bit value “0” to each non-deduplicated message information file. Decoding the multi-bit message based on the detection of which of the uploaded message information files are deduplicated may also include determining an ASCII character from the assigned bit values of the uploaded message information files.

According to yet other examples, the method may further include pre-generating the set of possible message start files, the set of possible message information files, and the set of possible message end files rising sequential, timestamps, where the timestamps are generated according to a pre-arranged scheme with an insider that uploads the multi-bit message. The method may also include identifying the message start files, the message information files, and the message end files by setting a value in a file type field of each uploaded file to the cloud storage by the capturer.

According to further examples, systems configured to provide a multi-bit message exchange over a covert channel in cloud storage systems are described. An example system may include an insider module configured to execute on a first computing device that hosts a victim configured to upload files to a cloud storage. The insider module may be further configured to upload a message start file to the cloud storage in response to detection of a file upload action by the victim, where the message start file includes a start time. The insider module may upload a number of message information files to the cloud storage, where each message information file includes a distinct timestamp, and upload a message end file to the cloud storage, where the message end file includes an end time while the victim is continuing the file upload action; and stop the upload of the message information files or the message end file in response to detection of a completion of the file upload action by the victim. The system may also include a capturer module configured to execute a second computing device communicatively coupled to the cloud storage. The capturer module may upload a set of possible message start files to the cloud storage, where the set of possible message start files include a first set of distinct timestamps, upload a set of possible message end files in response to detection of a deduplication of one of the set of possible message start files at the cloud storage, where the set of possible message end files include a second set of distinct timestamps; upload a set of possible message information files corresponding to a start timestamp and an end timestamp defined by the deduplicated message start file and the deduplicated. message end file in response to detection of a deduplication of one of the set of possible message end files at the cloud storage; and decode the multi-bit message uploaded by the insider to the cloud storage based on a detection of which of the uploaded message information files are deduplicated at the cloud storage.

According to yet further examples, the cloud storage may employ cross-user data deduplication. The insider module may be further configured to encode a multi-bit message according to ASCII coding. The capturer module may be further configured to determine an ASCII character from assigned bit values of the uploaded message information files. The message start files, the message information files, and the message end files may each include a random content field, a file type field, and a timestamp field. Timestamp values for the message start files, the message information files, and the message end files may be by a file generator used by the insider module and the capturer module.

The use of hardware or software is generally (but not always, in that in certain contexts the choice between hardware and software may become significant) a design choice representing cost vs efficiency tradeoffs. There are various vehicles by which processes and/or systems and/or other technologies described herein may be effected (for example, hardware, software, and/or firmware), and that the preferred vehicle will vary with the context in which the processes and/or systems and/or other technologies are deployed. For example, if an implementer determines that speed and accuracy are paramount, the implements may opt for a mainly hardware and/or firmware vehicle; if flexibility is paramount, the implementer may opt for a mainly software implementation, or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such, block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, may be equivalency implemented in integrated circuits, as one or more computer programs running on one or more computers (for example, as one or more programs running on one or more computer systems), as one or more programs running on one or more processors (for example as one or more programs running on one or more microprocessors), as firmware, or as virtually any combination thereof and that designing the circuitry and/or writing the code for the software and or firmware are possible in light of this disclosure.

The present disclosure is not to be limited in terms of the particular embodiments described in this application, which are intended as illustrations of various aspects. Many modifications and variations can be made without departing from its spirit and scope. Functionally equivalent techniques and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, the mechanisms of the subject matter described herein are capable of being distributed as a program product in a variety of forms, and an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (for example, a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such, described devices and/or processes into data processing systems. That is, at least a portion of the devices and/or processes described herein may be integrated into a data processing system via a reasonable amount of experimentation. A typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

A typical data processing system may be implemented using any suitable commercially available components, such as those typically found in data computing/communication and/or network computing/communication systems. The herein described subject matter sometimes illustrates different components contained within, or connected with, different other components. Such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to” etc.). It will be further understood by those within the art that if a specific number of an introduced claim recitation is intended, such an intent, will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that, the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in. the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various compositions, techniques, systems, and devices are described in terms of “comprising” various components or steps (interpreted as meaning “including, but not limited to”), the compositions, techniques, systems, and devices can also “consist essentially of” or “consist of” the various components and steps, and such terminology should be interpreted as defining essentially closed-member groups.

As will be understood by one skilled in the art, for any and all purposes, such as in terms of providing a written description, all ranges disclosed herein also encompass any and all possible subranges and combinations of subranges thereof. Any listed range can be recognized as sufficiently describing and enabling the same range being broken down into at least, equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

What is claimed is:

1. A method to provide a multi-bit message over a covert channel in cloud storage systems, the method comprising:
in response to detection of a file upload action by a victim residing on a computing device, uploading a message start file to a cloud storage by an insider residing on the same computing device as the victim, wherein the message start file includes a start time;
while the victim is continuing the file upload action,
uploading a number of message information files to the cloud storage by the insider, wherein each message information file includes a distinct timestamp, and
uploading a message end file to the cloud storage by the insider, wherein the message end file includes an end time; and
in response to detection of a completion of the file upload action by the victim, stopping the uploading of the message information files or the message end file.

2. The method of claim 1, wherein uploading the number of message information files to the cloud storage with each message information file including the distinct timestamp comprises:
pre-generating the message information files with sequential timestamps.

3. The method of claim 2, wherein the sequential timestamps have values between the start time and the end time.

4. The method of claim 2, further comprising:
generating the start time, the end time, and the time-stamps of the message information files using a pre-arranged scheme with a capturer to ensure decoding of the multi-bit message by the capturer upon completion of the upload of the message end file.

5. The method of claim 1, further comprising:
indicating the start time and the end time by using a start timestamp and an end timestamp, wherein the start timestamp and the end timestamp are based on insider generated time points.

6. The method of claim 1, further comprising:
uploading a message information file to indicate a bit “1” to a capturer; and
refraining from uploading a message information file to indicate a bit “0” to the capturer.

7. The method of claim 1, further comprising:
upon completion of the upload of the message end file, deleting the pre-generated message start file, the message information files, and the message end file from the computing device shared by the insider and the victim.

8. The method of claim 1, further comprising:
encoding the multi-bit message according to ASCII coding.

9. The method of claim 1, further comprising:
identifying the message start file, the message information files, and the message end file by setting a value in a file type field of each uploaded file to the cloud storage by the insider.

10. A method to decode a multi-bit message over a covert channel in cloud storage systems, the method comprising:
uploading a set of possible message start files to a cloud storage by a capturer, wherein the set of possible message start files include a first set of distinct timestamps;
in response to detection of a deduplication of one of the set of possible message start files at the cloud storage, uploading a set of possible message end files by the capturer, wherein the set of possible message end files include a second set of distinct timestamps;
in response to detection of a deduplication of one of the set of possible message end files at the cloud storage, uploading a set of possible message information files corresponding to a start timestamp and an end timestamp defined by the deduplicated message start file and the deduplicated message end file to the cloud storage by the capturer; and
decoding the multi-bit message uploaded by an insider to the cloud storage based on a detection of which of the uploaded message information files are deduplicated at the cloud storage.

11. The method of claim 10, wherein decoding the multi-bit message based on the detection of which of the uploaded message information files are deduplicated comprises:
assigning a bit value “1” to each dedpulicated message information file.

12. The method of claim 11, wherein decoding the multi-bit message based on the detection of which of the uploaded message information files are dedpulicated farther comprises:
assigning a bit value “0” to each non-deduplicated message information file.

13. The method of claim 12, wherein decoding the multi-bit message based on the detection of which of the uploaded message information files are dedpulicated farther comprises:
determining an ASCII character from the assigned bit values of die uploaded message information files.

14. The method of claim 10, further comprising:
pre-generating the set of possible message start files, the set of possible message information files, and the set of possible message end files using sequential timestamps, wherein the timestamps are generated according to a pre-arranged scheme with an insider that uploads the multi-bit message.

15. The method of claim 10, further comprising:
identifying the message start files, the message information files, and the message end files by setting a value in a file type field of each uploaded file to the cloud storage by the capture.

16. A system configured to provide a multi-bit message exchange over a covert channel in cloud storage systems, the system comprising:
an insider module configured to execute on a first computing device that hosts a victim configured to upload files to a cloud storage, the insider module further configured to:
in response to detection of a file upload action, by the victim, upload a message start, file to the cloud storage, wherein the message start file includes a start time; while the victim is continuing the file upload action,
upload a number of message information files to the cloud storage, wherein each message information file includes a distinct timestamp, and
upload a message end file to the cloud storage, wherein the message end file includes an end time; and
in response to detection of a completion of the file upload action by the victim, stop the upload of the message information files or the message end file; and
a capturer module configured to execute a second competing device communicatively coupled to the cloud storage, wherein the capturer module is configured to:
upload a set of possible message start files to the cloud storage, wherein the set of possible message start files include a first set of distinct timestamps;
in response to detection of a deduplication of one of the set of possible message start files at the cloud storage, upload a set of possible message end files, wherein the set of possible message end files include a second set of distinct timestamps;
in response to detection of a deduplication of one of the set of possible message end files at the cloud storage, upload a set of possible message information files corresponding to a start timestamp and an end timestamp defined by the deduplicated message start life and the deduplicated message end file; and
decode the multi-bit message uploaded by the insider to the cloud storage based on a detection of which of the uploaded message information files are deduplicated at the cloud storage.

17. The system of claim 16, wherein the cloud storage employs cross-user data deduplication.

18. The system of claim 16, wherein
the insider module is further configured to:
encode a multi-bit message according to ASCII coding; and
the capturer module is further configured to:
determine an ASCII character from assigned bit values of the uploaded message information files.

19. The system of claim 16, wherein the message start files, the message information files, and the message end files each include a random content field, a file type field, and a timestamp field.

20. The system of claim 16, wherein timestamp values for the message start files, the message information files, and the message end files are generated by a file generator used by the insider module and the capturer module.
